(19) United States
(12) Patent Application Publication
(10) Pub. No.: US 2012/0050873 A1
(43) Pub. Date: Mar. 1, 2012

(54) WAVELENGTH TUNABLE OPTICAL FILTER AND REFLECTING ELEMENT FOR AN OPTICAL DEVICE

(75) Inventor: Cornel Marxer, Neuchatel (CH)

(73) Assignee: SERCALO MICROTECHNOLOGY LIMITED, Schaan (LI)

(21) Appl. No.: 13/218,228

(22) Filed: Aug. 25, 2011

(30) Foreign Application Priority Data
Aug. 25, 2010 (EP) 10174016.5

(51) Int. Cl. G02B 5/26; G02B 5/08

(52) U.S. Cl. 359/615; 359/883

(57) ABSTRACT

The invention relates to an optical filter comprising an optical source (2), emitting a light beam comprising a plurality of wavelengths, an optical receiver (3), and, optically aligned between the source (2) and receiver (3), at least one collimating and converging optical element (10), one dispersive optical element (20) capable of angularly separating the wavelengths, and a reflecting element (30) mobile about an axis (AA) capable, depending on its orientation about the axis (AA), of reflecting a specific wavelength toward the optical receiver (3). The optical elements (10, 20, 30) are arranged so that the light beam passes at least once through the dispersive element (20) before reaching the optical receiver (3). According to the invention the reflecting element (30) includes at least two faces (31, 32) defining a first and a second plane intersecting on a line parallel to the axis (AA) of rotation of the reflecting element (30).

### CROSS-REFERENCE TO RELATED APPLICATIONS

This application claims priority to European Patent Application No. 10174016.5 filed on Aug. 25, 2010, the entirety of which is incorporated by this reference.

### BACKGROUND OF THE INVENTION

1. Field of the Invention

The present invention relates to the field of transmission, and in particular to the wavelength demultiplexing, of optical signals. It relates more particularly to a wavelength-tunable optical filter comprising an optical source, a collimating and converging element, a dispersive element, a rotatably mobile reflecting element, and an optical receiver.

2. State of the Art

Such optical filters are well known to the person skilled in the art. They are used especially in modern fibre-optic telecommunications systems. Optical fibres generally carry a light beam having a plurality of light waves of different wavelengths λ1, λ2, . . . λn, providing the medium for a plurality of information flows to be transmitted. For this purpose the different light waves are phase or amplitude modulated, the information being contained in the modulation. The frequency spectrum of the light beam is thus constituted by a plurality of emission bands centred on frequencies f1, f2, . . . fn corresponding to wavelengths λ1, λ2, . . . λn. An example of this type of optical signal is shown schematically in FIG. 1, in the form of a graph plotting signal intensity as a function of wavelength λ. The width of the bands is typically 40 GHz, the interval between two consecutive emission bands being 50 GHz. In each band, the frequency spectrum carrying a flow of information is of the symmetrical type and occupies the entire bandwidth.

To extract the information contained in each light wave by converting the optical signal into an electrical signal, it is necessary, at the optical fibre output, to filter the different spectral bends. This operation is called wavelength demultiplexing.

During wavelength demultiplexing, the frequency spectrum contained in each emission band must be reproduced as faithfully as possible. Specifically, deformation of the frequency spectrum ultimately leads to distortion of the extracted information relative to the transmitted information. Wavelength demultiplexing is therefore a first step in a processing sequence aimed at restoring the information carried by the light signal, which directly determines the quality of the information ultimately delivered.

The wavelength demultiplexing operation is generally performed with the aid of a wavelength-tunable optical filter. A description of such an optical filter is given in the journal ‘The Optical Fiber Communication Conference and Exposition’, 2003, Volume 1, page 252-253. It essentially comprises an optical source and receiver, optically aligned in a plane P, formed from a first and a second optical fibre, a dispersive optical element capable of angularly separating the wavelengths of the light beam emitted by the source in the plane P, and a reflecting element mobile about an axis AA perpendicular to the plane P, capable, depending on its orientation about the axis AA, of reflecting a wavelength toward the optical receiver. It additionally includes a collimating and converging element, such as a lens, of focal length F, and a quarter-wave plate. The collimating and converging element is located at the distance F from the first and second optical fibres, which are disposed substantially symmetrically about its axis of symmetry. The various optical elements are aligned relative to each other.

The operating principle of such a device is as follows. The light beam emitted by the source passes through the collimating element from which it emerges parallel. The beam thus coil mated is directed onto the dispersive element, and emerges therefrom with variable angles in the plane P, as a function of the wavelength. It then passes through the quarter-wave plate and strikes the reflecting element. The beam is then reflected towards the dispersive element, at varying angles of incidence depending on the wavelength, and is then directed back to the collimating element. At the output of the converging and collimating element, a single wavelength λi converges towards the optical receiver, while the other wavelengths converge towards different points aligned on both sides of the optical receiver.

The spectral response of this type of optical filter, which is a combination of the response of the diffraction grating and the acceptance angle of the optical receiver, is of the Gaussian type. This point poses a problem. Specifically, the various emission bands being of the square type, they show distortions after filtering by a Gaussian. Essentially, the band-edge frequencies are attenuated or even cut off by the Gaussian, and consequently the frequency spectrum which contains the initial information is poorly rendered. This results in distortion of the final electrical signal.

### SUMMARY OF THE INVENTION

The purpose of the present invention is to improve the optical filtering carried out, in a very simple manner, by providing, instead of a Gaussian type filter band, one formed from a mixture of at least two Gaussians of which the amplitudes and the interval between peaks can be optimised to impart as square a profile as possible to the spectral response. More specifically, the invention relates to an optical filter comprising an optical source emitting a light beam comprising a plurality of wavelengths, an optical receiver and, optically aligned between the source and receiver, at least one collimating and converging optical element, a dispersive optical element capable of angularly separating the wavelengths, and a reflecting element mobile about an axis AA, capable, depending on its orientation about the axis AA, of reflecting a specific wavelength toward the optical receiver, the optical elements being arranged so that the light beam passes at least once through the dispersive element before reaching the optical receiver. According to the invention, the reflecting element includes at least two faces defining a first and a second plane intersecting along a line parallel to the axis AA of rotation of the reflecting element. By virtue of this characteristic of the optical filter according to the invention, its spectral response is not Gaussian, and the frequency spectrum of the emission bands is rendered with a minimum of distortion.

The invention also relates to a reflecting element for an optical device formed from a silicon wafer, having an active face and a rear face. According to the invention, the reflecting element comprises at least one structure formed from a thin layer of a material having a stress differential with the silicon and disposed on the wafer so as to fold it on at least one straight line. By virtue of this characteristic, the reflecting element comprises at least two non-parallel faces capable of reflecting light rays in at least two different directions.

### BRIEF DESCRIPTION OF THE DRAWINGS

Other characteristics and advantages of the present invention will emerge more clearly from the following detailed description of an example embodiment of an optical filter according to the invention, this example being given purely by way of non-limitative illustration, in conjunction with the attached drawing in which:

FIGS. 2 and 3 are schematic views in longitudinal cross-section, respectively in planes (xOy) and (zOyO′y′), of a first embodiment of an optical filter according to the invention,

FIGS. 4 and 5 are sectional views in a plane (xOy), respectively of a first and second version, of an element of the optical filter according to the invention;

FIG. 6 is a front view of the said element in its first variant,

FIGS. 7 and 8 illustrate two examples of spectral responses of an optical filter according to the invention, and

FIG. 9 is a schematic view in longitudinal cross-section in a plane (xOy) of a second embodiment of a filter according to the invention.

### DETAILED DESCRIPTION OF THE ILLUSTRATED EMBODIMENTS

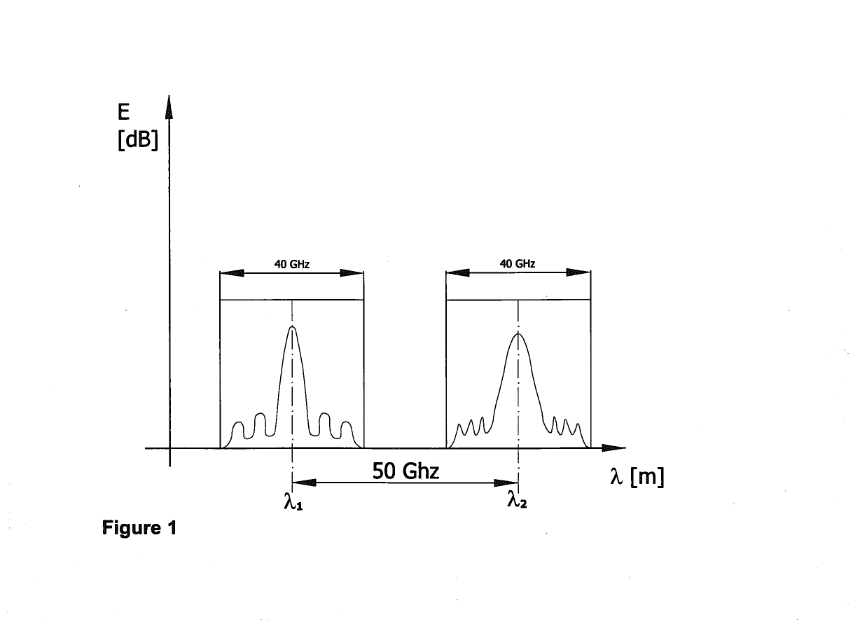

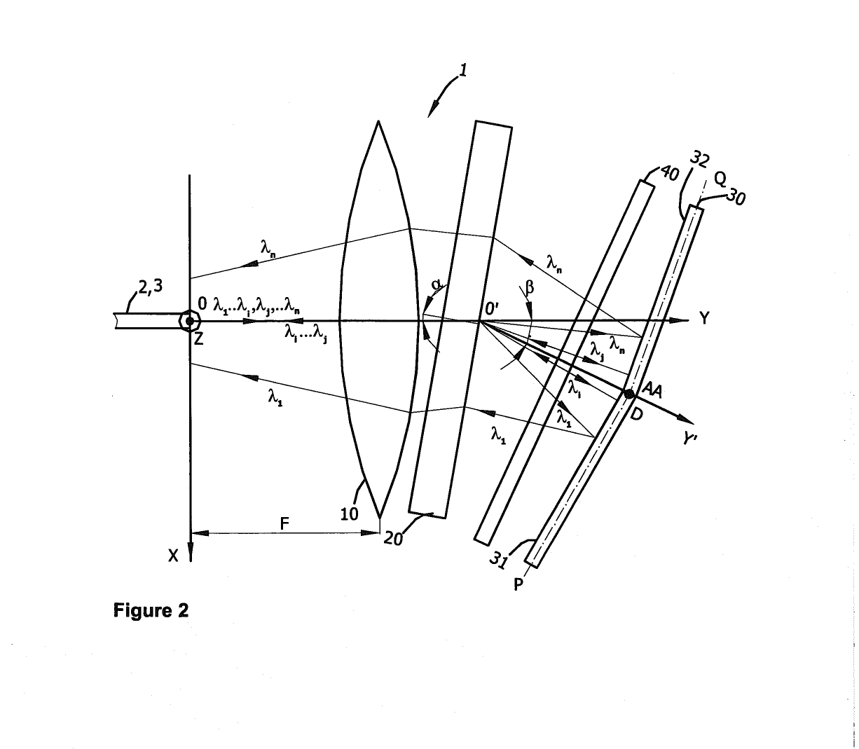

By way of preliminary remark to the description which follows, it will be noted that the relative dimensions of the various elements have not been adhered to in FIGS. 2 to 6 and 9 so as to facilitate understanding of the invention. The wavelength-tunable optical filter shown schematically in these figures, and referenced overall as 1, is positioned relative to a system of axes (Oxyz) of orthogonal type. It typically includes a collimating and converging element 10, such as a lens, a dispersive element 20, such as a diffraction grating, and a reflecting element 30, such as a mirror. The diffraction grating 20 can be configured either for reflection or transmission. The embodiment described herein below shows a grating configured for transmission, but the person skilled in the art may, without inventive step, choose to replace it by a grating configured for reflection. Its resolution depends on the density of the diffraction structures. A density of 1000 lines per millimetre is typically chosen, and this value can be increased or decreased depending on the desired resolution.

The optical elements 10, 20, 30 are optically aligned so that a collimated light beam leaving the lens 10 falls on the grating 20 at a determined angle of incidence α, is then diffracted by the said grating 20 in the plane (xOy), the first order being directed substantially toward the centre of the mirror 30. To this end, the lens 10 is located on the axis Oy, at a distance F from the origin O, corresponding to its focal length. Its axis of symmetry is coincident with the axis Oy. The grating 20, with structures parallel to the axis Oz, is located on the axis Oy, after the lens 10, its axis of symmetry forming an angle α with the same axis Oy. The angle α is chosen so as to maximise the effectiveness of the grating 20. An angle between 40° and 50° for a wavelength of 1550 nanometres will be chosen for example.

We now denote O′y′ the axis of origin O′ located at the intersection between the output face of the grating 20 and the axis Oy, and forming an angle β with the axis Oy. The angle β corresponds to the first-order diffraction angle of a beam impinging on the grating 20 at an angle of incidence α. The mirror 30 is located on the axis O′y′, which intersects it at its centre C. It is rotatably mobile about an axis AA parallel to the axis Oz and passing through its centre C, actuated by an electrostatic or electromechanical stepper motor, in a manner well known to the person skilled in the art.

The optical filter 1 additionally comprises a quarter-wave plate 40, interposed between the grating 20 and the mirror 30, whose axis coincides with the axis O′y′, and designed to reduce fluctuations in the optical losses of the optical filter 1. Specifically, it is known that in most cases diffraction gratings are sensitive to the polarization of a beam passing therethrough. If the beam presents temporal variations of polarization, a change of polarization by 45° will make it possible to reduce these variations. Another solution is to use a grating 20 which has limited sensitivity to the polarization of the beam that it diffracts.

The optical filter 1 also includes an optical source 2 and an optical receiver 3, such as single-mode or multi-mode optical fibres. The optical fibres 2 and 3 are aligned along the axis Oz, symmetrically about the origin O, their axes of symmetry being parallel to the axis Oy. They are located at the distance F from the lens 10, and at a distance L from the mirror 30, chosen so that a light beam emitted by the source optical fibre 2 is reflected towards the receiving optical fibre 3.

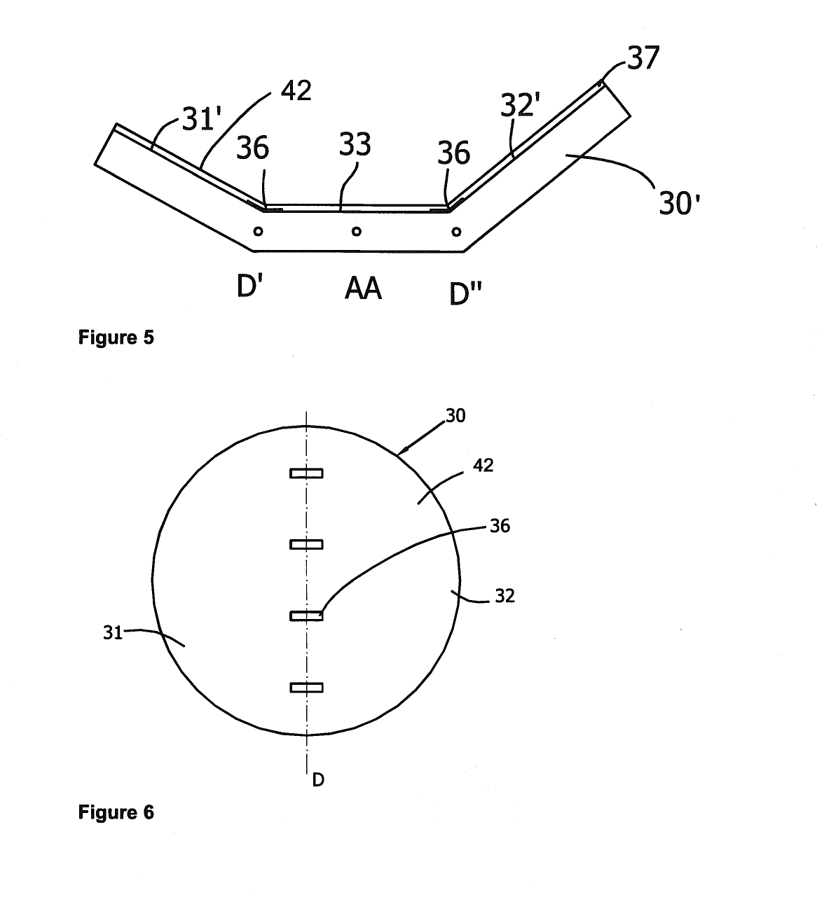

According to the invention, the mirror 30 comprises at least two faces 31 and 32, defining two planes P and Q whose intersection defines a straight line D parallel to the axis of rotation AA. The said mirror 30 is shown in two variants, respectively, in cross-section in FIGS. 4 and 5, and in front view in FIG. 6. In the variant shown in FIG. 4, the mirror 30 has two faces 31 and 32 and the line D is coincident with the axis of rotation AA of the mirror 30. The two faces 31 and 32 form between them an angular sector φ, close to 180°, such that each of them can be presented perpendicular to a first-order diffraction wavelength, respectively λ₁ and λ₂ of an incident beam. In practice, the angle φ is comprised between 180°±0.08°, excluding the value 180°. Typically it is equal to 180°−0.04°. In the variant shown in FIG. 5, the mirror 30′ has three faces 31′, 32′ and 33, defining three planes P′, Q′ and S′, whose intersections define two straight lines, respectively D′ and D″ parallel to the axis AA.

The mirror 30 is formed from a silicon wafer having an active face 42 and a rear face 41, typically from an SOI wafer (Silicon On Insulator) by photolithographic processes well known to the person skilled in the art. It is small in size, for example 1 to 3 millimetres in diameter and 15 microns thick. It includes one or more structures 36 on the active face 42 or rear face 41, formed by a thin layer of a material having a stress differential with the silicon, and designed to fold the wafer to form at least two faces 31, 32. Such a material is, for example, silicon nitride or silicon oxide. The said structures 36 are formed, for example, by a plurality of bands of silicon nitride Si3N4, with dimensions of about 50 to 150 microns, aligned along the line D, or the lines D′ and D″, on the active face 42 of the mirror 30. These bands, about 200 nanometres thick, are deposited by a physicochemical process such as PECVD, LPCVD or any other process well known to the person skilled in the art. They have a stress in tension, which has the effect of folding mirror 30 along the line on which they are aligned, and of forming two faces 31 and 32, or more. Alternatively, the structure 36 is formed from a single band disposed along the line D. In another variant, the structures 36 are formed from silicon oxide SiO2 and aligned on the rear face of the mirror 30. In this case, they have a stress in compression, which also has the effect of folding the mirror 30, but from the rear face. The mirror 30 may or may not be covered with a reflective metal layer 37 formed from a gold-chromium or gold-titanium alloy.

The operating principle of the optical filter 1 according to the invention will now be described. The source optical fibre 2 emits a divergent light beam formed from a plurality of light waves of wavelengths λ1, λ2, . . . λn, phase or amplitude modulated, of any polarization. The beam passes through the lens 10 from which it emerges parallel, then is directed towards the grating 20 at an angle of incidence α. The first-order diffraction emerges from the grating 20 generally at an angle β and passes through the quarter-wave plate 40, which has the effect of changing the polarization of the beam F by 45°.

The beam is then directed towards the mirror 30, on which it impinges at variable angles of incidence, depending on the wavelength. The wavelengths λi and λj perpendicular, respectively, to the faces 31 and 32 of the mirror 30, are reflected in the same direction towards the grating 20, from which they emerge parallel to the axis Oy. They then pass through the lens 10, from which they emerge convergent towards the receiving optical fibre 3. The orientation of the mirror 30 about its axis of rotation AA determines the wavelengths λi and λj selected. The other wavelengths λ1, λ2, . . . λn non-perpendicular to the faces 31 and 32 are reflected back towards the grating 20 symmetrically relative to their angle of incidence, and emerge therefrom non-parallel to the axis Oy. They converge at the outlet of the lens 10 towards a plurality of points aligned parallel to the axis Ox, on both sides of the receiving optical fibre 3.

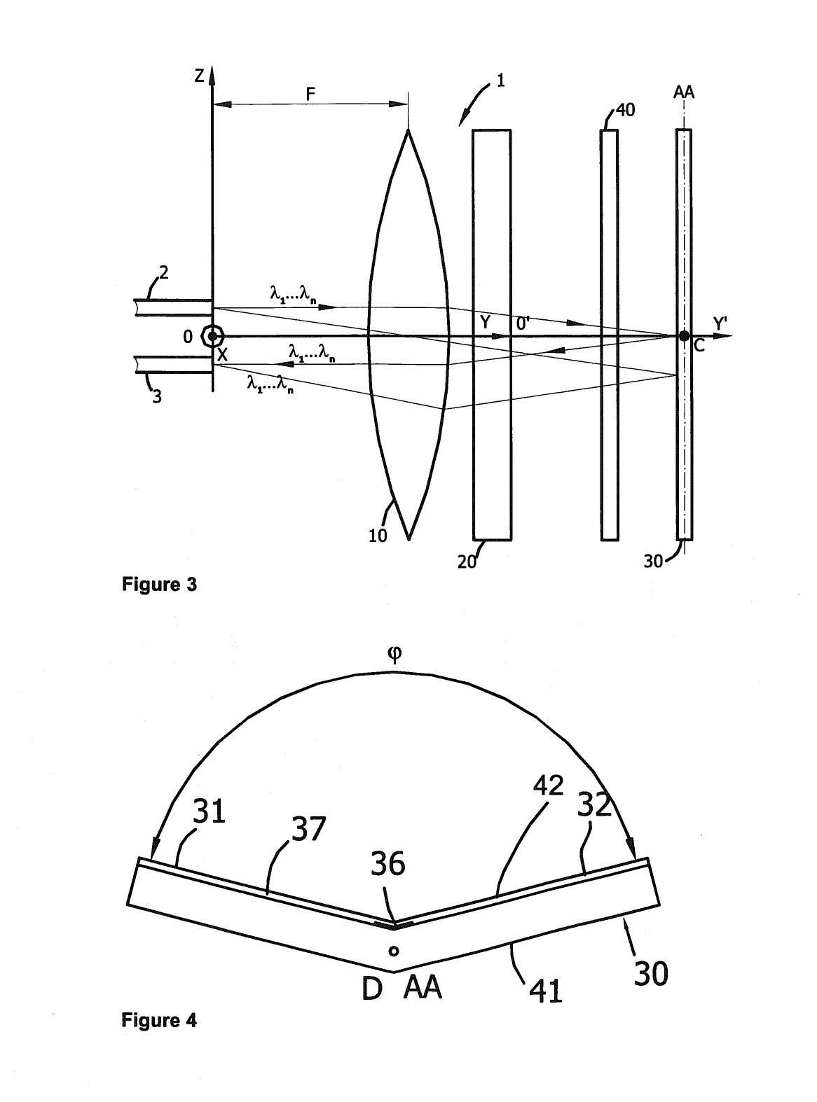

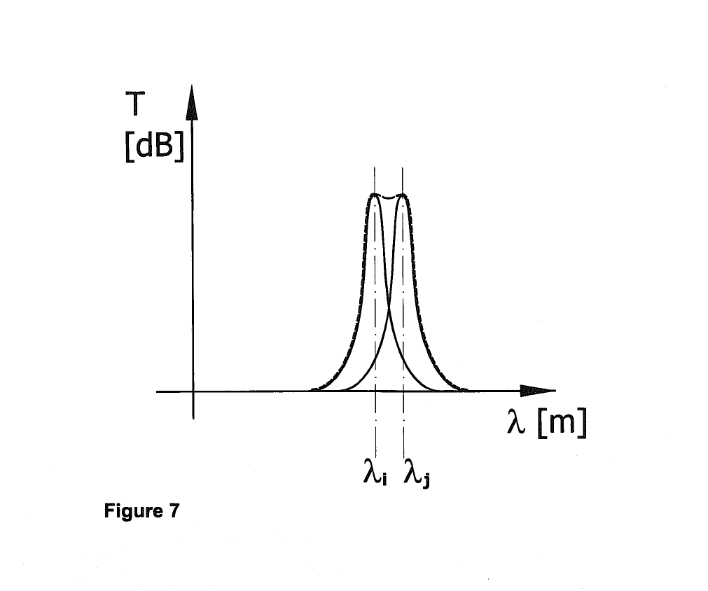

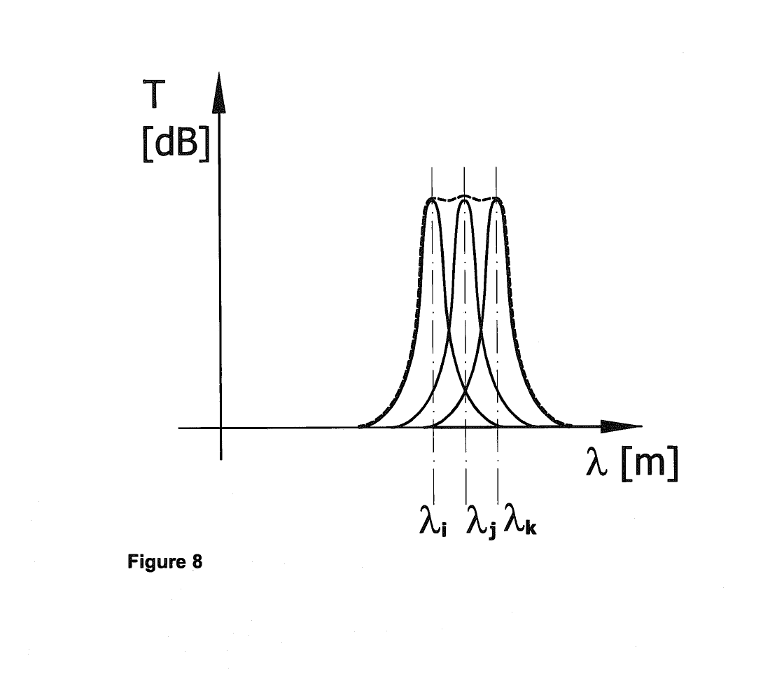

Referring now to FIGS. 7 and 8, which illustrate two examples of spectral responses of a filter according to the invention, in the form of graphs showing the transmission T as a function of wavelength λ. It is known that the spectral response of a conventional optical filter is of Gaussian type. By virtue of the two faces 31 and 32 of the mirror 30, the bandwidth of the filter 1 described with reference to FIGS. 2 and 3 is a mixture of two Gaussians each centred on the wavelengths λi and λj. For a given diffraction grating 20, the distance between the wavelengths λi and λj depends only on the angle φ between the two faces 31 and 32 of the mirror 30. The angle φ will therefore be chosen judiciously in order to obtain a pass-band as square as possible. As illustrated in FIG. 7, the pass-band of the filter according to the invention has a substantially square profile, of which the peak is flatter than that of a Gaussian. Such a filter renders the optical spectrum of an emission band with minimal distortion.

The shape of the pass-band of the filter according to the invention can be optimised by varying the number of faces of the mirror 30, their widths, and their respective angles. In FIG. 8, for example, there is shown a pass-band of a filter having a mirror with three symmetrical faces. The pass-band is formed from the sum of three identical evenly-spaced Gaussians. Its profile is wider and squarer than the profile shown in FIG. 5. By varying the width of the central face 33, the height of the central Gaussian can either be decreased or increased according to the desired final profile. The angular variation between the different faces 31′, 32′, 33, also makes it possible to modify the spacing between the Gaussians, and therefore to adapt the shape of the spectral band. Thus, the optical filter according to the invention offers a multitude of possible configurations, depending on the desired filtering. It makes it possible, for example, to obtain a pass-band peak substantially free of ripple.

We have thus described a wavelength-adaptable optical filter equipped with a rotatably mobile mirror of which the geometry enables optimisation of the wavelength filtering of a light beam. Of course, the filter of the invention is not limited to the embodiment just described, and various simple modifications and variants can be envisaged by the person skilled in the art without departing from the scope of the invention as defined by the appended claims.

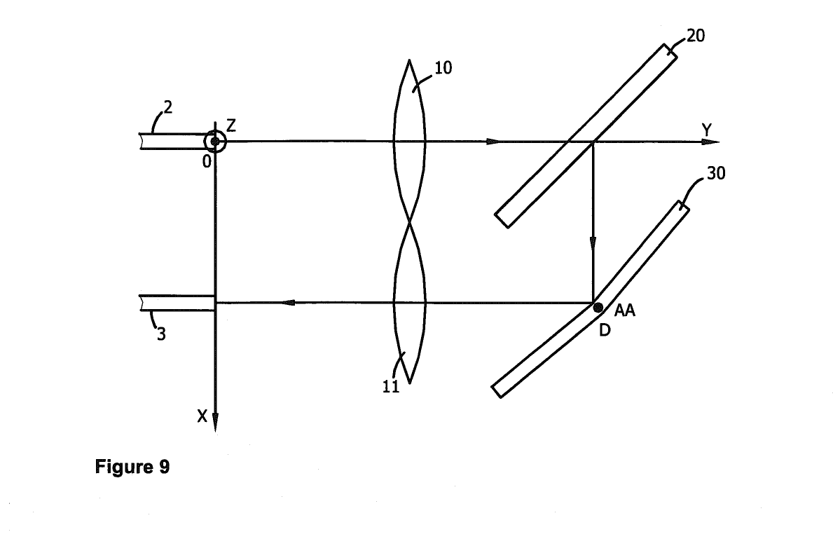

There is shown, for example in FIG. 9, a second embodiment of an optical filter 1 according to the invention having only one passage through the diffraction grating 20. It differs from the filter 1 illustrated in FIGS. 2 and 3 in that it has a second collimating and converging element 11, and in that the mirror 30 is aligned to return the light beam to the optical receiver 3, through the said second collimating and converging element 11. The source 2 and the receiver 3 are aligned in the plane xOy and are not superimposed in the plane zOy. The operating principle of such an optical filter is similar to that of the filter described with reference to FIGS. 2 and 3, except that the beam makes a single passage through the dispersive element 20.

1. An optical filter comprising:
an optical source emitting a light beam comprising a plurality of wavelengths;
an optical receiver; and
optically aligned between said optical source and said optical receiver, at least one collimating and converging optical element, a dispersive optical element capable of angularly separating the plurality of wavelengths, and a reflecting element mobile about an axis of rotation capable, depending on its orientation about the axis of rotation, of reflecting a specific wavelength toward the optical receiver, the reflecting element including at least two faces defining a first and a second plane intersecting along a line parallel to the axis of rotation of the said reflecting element and the at least one collimating and converging optical element, the dispersive optical element and the reflecting element being arranged so that the light beam passes at least once through the dispersive optical element before reaching the optical receiver.

2. The optical filter according to claim 1, wherein the line is coincident with the axis of rotation.

3. The optical filter according to any claim 1, wherein the at least two faces define therebetween an angular sector greater than 180°−0.08° and less than 180°+0.08°.

4. The optical filter according to claim 1, wherein the reflecting element includes a third face defining a third plane intersecting the first and second planes along two lines parallel to the axis of rotation of the reflecting element.

5. The optical filter according to claim 1, wherein the at least one collimating and converging optical element, the dispersive optical element and the reflecting element are arranged so that the light beam makes two passes through the dispersive optical element.

6. The optical filter according to claim 5, wherein the optical source and the optical receiver are superimposed in a first plane along an axis, and in that the dispersive optical element is arranged to angularly separate the wavelengths of the light beam in a second plane perpendicular to the first plane.

7. The optical filter according to claim 6, wherein the collimating and converging optical element is located on a first axis at a distance, corresponding to its focal length, from an origin, and in that an axis of symmetry of the collimating and converging optical element is coincident with the first axis.

8. The optical filter according to claim 7, wherein the dispersive element is located on the axis Oy, its axis of symmetry forming an angle α with the axis Oy.

9. The optical filter according to claim 6 wherein the reflecting element is located on a second axis O′y′, forming an angle with the first axis corresponding to a first-order dispersion angle of the dispersive element.

10. The optical filter according to claim 1, wherein the optical source and optical receiver are optical fibres.

11. A reflecting element, comprising:
a silicon wafer having an active face and a rear face;
at least one structure formed from a thin layer of a material having a stress differential with silicon and disposed on the silicon wafer to fold the silicon wafer along at least one line.

12. The reflecting element according to claim 11, wherein the structure is disposed on the active face, and wherein the material is silicon nitride.

13. The reflecting element according to claim 11, wherein the structure is disposed on the rear face, and wherein the material is silicon oxide.

14. The reflecting element according to claim 11, wherein the structure is comprised of a plurality of structures formed from bands aligned along the line.

15. The reflecting element according to claim 11, wherein the structure is formed from a single band disposed along the line.
